(19) United States
(12) Patent Application Publication
(10) Pub. No.: US 2026/0016289 A1
(43) Pub. Date: Jan. 15, 2026

(54) DEPTH SENSOR DEVICE AND METHOD FOR OPERATING A DEPTH SENSOR DEVICE

(71) Applicant: Sony Semiconductor Solutions Corporation, Kanagawa (JP)

(72) Inventor: Michael GASSNER, Stuttgart (DE)

(73) Assignee: Sony Semiconductor Solutions Corporation, Kanagawa (JP)

(21) Appl. No.: 18/995,900

(22) PCT Filed: Jun. 21, 2023
(86) PCT No.: PCT/EP2023/066856

§ 371 Date: Jan. 17, 2025

(30) Foreign Application Priority Data
Jul. 27, 2022 (EP) 22187249.2

(51) Int. Cl. G01B 11/25; G01B 11/22

(52) U.S. Cl. CPC G01B 11/254; G01B 11/22

(57) ABSTRACT

A sensor device for generating a depth map of an object includes a projector unit, a receiver unit, and a control unit. The projector unit projects multiple illumination patterns in a predefined projection solid angle, determining for each solid angle whether to project light. The receiver unit, equipped with multiple pixels, detects reflected light intensities during illumination and generates events when intensity changes exceed a threshold. The control unit adjusts illumination patterns, collects event data, and maps the reflected patterns to corresponding pixels. This enables the generation of a depth map by associating solid angles with pixel locations based on event data.

### FIELD OF THE INVENTION

The present disclosure relates to a sensor device and a method for operating a sensor device. In particular, the present disclosure is related to the generation of a depth map.

### BACKGROUND

In recent years techniques for automatic measuring of distances by sending and receiving light have drawn much attention to them. One such technique is the usage of structured light, i.e. the illumination of an object with static or time varying sparse light patterns in various solid angles such as to generate e.g. line, bar or checkerboard patterns. For a known orientation of light source and camera it is possible to determine the shape and the distance of an object from triangulation based on the known positions of the light source, the camera, the orientation of the emitted light in space, and the position of the according light signal on the camera.

It is desirable to improve the resolution, the accuracy and the capture time of the depth maps obtained from triangulation.

### SUMMARY OF THE INVENTION

In conventional systems for depth estimation a set of illumination patterns providing high intensities at predetermined solid angles is sent out to an object and the distribution of light reflected from the object is measured by a receiver such as a camera. The task is then to find for the known solid angles of light emission, the solid angles of maximum light reception on the receiver. Due to the limited density of intensity changes in the illumination pattern and the limited pixel resolution, for the determination of the solid angle of maximum light reception a fit of the expected intensity distribution to the measured intensity values has to be made. In conventional systems this requires storage of all intensity values obtained at all pixels of the camera for all different illuminations. Only after all intensity values have been stored, a depth map can be generated. Thus, in conventional systems memory space must be large. Further, complete storage of intensity values leads to an enhanced latency in the system. Also, the available pixel resolution is limited by the readout speed, if applications with real-time behavior are envisaged, since too many pixels will lead to too long processing times.

These shortcomings of conventional depth estimation techniques may be mitigated by using event based sensors, i.e. sensors that are sensitive only to changes in the received signal. However, here the problem exists that the readout characteristics of an event sensor introduces additional inaccuracies, if the used illumination patterns do not lead to event sequences that are sufficiently robust against temporal dynamics in the readout process. The present disclosure aims at also mitigating this problem.

To this end, a sensor device for generating a depth map of an object is provided. The sensor comprises a projector unit that is configured to project in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it, a receiver unit that comprises a plurality of pixels, the receiver unit being configured to detect on each pixel intensities of light reflected from the object while it is illuminated with the illumination patterns, and to generate an event at one of the pixels if the intensity detected at the pixel changes by more than a predetermined threshold, and a control unit that is configured to control the form of the illumination patterns, to receive event data indicating the events generated while the object is illuminated with the illumination patterns, and to generate a depth map of the object based on the received event data. Here, the control unit is configured to control the form of the illumination patterns such that the temporal sequence of illuminations of each predetermined solid angle allows determining from the event data which of the predetermined solid angles has been mapped to which of the pixels by reflection of the illumination pattern on the object.

Further, a method for operating a sensor device for generating a depth map of an object is provided, the method comprising: projecting in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it; detecting, on each of a plurality of pixels, intensities of light reflected from the object while it is illuminated with the illumination patterns, and generating an event at one of the pixels if the intensity detected at the pixel changes by more than a predetermined threshold; receiving event data indicating the events generated while the object is illuminated with the illumination patterns, and generating a depth map of the object based on the received event data; and controlling the form of the illumination patterns such that the temporal sequence of illuminations of each predetermined solid angle allows determining from the event data which of the predetermined solid angles has been mapped to which of the pixels by reflection of the illumination pattern on the object.

Instead of using intensity information of all pixels use is made of the properties of event vision sensors (EVS)/dynamic vision sensors (DVS) which only detect changes in intensities. Since the illumination patterns used for depth map generation are usually sparse, events will pile up only at pixel positions that receive the reflection of the illumination pattern from the object. Thus, a reduction of memory can already be achieved due to the reduction of pixels that produce an output to be stored.

Further, by controlling the form of the illumination patterns in a manner that is robust against temporal pixel dynamics, it can be guaranteed that the event sequences received allow a precise mapping between received events and projected light patterns. This robustness against temporal pixel dynamics allows in turn increasing the spatial density of light transitions in the illumination patterns, since the reflections of the patterns can be distinguished more precisely. This leads to an improved resolution of the generated depth maps.

### BRIEF DESCRIPTION OF THE DRAWINGS

FIG. 1A is a simplified block diagram of the event detection circuitry of a solid-state imaging device including a pixel array.

FIG. 1B is a simplified block diagram of the pixel array illustrated in FIG. 1A.

FIG. 1C is a simplified block diagram of the imaging signal read-out circuitry of the solid state imaging device of FIG. 1A.

FIG. 2 shows schematically a sensor device.

FIG. 3 shows schematically another sensor device.

FIG. 4 shows schematically a response characteristic of an event sensor in a sensor device.

FIG. 5 shows an exemplary series of code words that encode illumination patterns.

FIGS. 6A and 6B show schematically event generation in response to different illumination patterns.

FIGS. 7A and 7B show schematically event generation in response to different illumination patterns.

FIG. 8 shows schematically spatial reproduction of a given series of illumination patterns.

FIGS. 9A and 9B show schematically temporal reproduction of a given series of illumination patterns.

FIGS. 10A and 10B show schematically different exemplary applications of a camera comprising a depth sensor device.

FIG. 11 shows schematically a head mounted display comprising a depth sensor device.

FIG. 12 shows schematically an industrial production device comprising a depth sensor device.

FIG. 13 shows a schematic process flow of a method of operating a sensor device.

FIG. 14 is a simplified perspective view of a solid-state imaging device with laminated structure according to an embodiment of the present disclosure.

FIG. 15 illustrates simplified diagrams of configuration examples of a multi-layer solid-state imaging device to which a technology according to the present disclosure may be applied.

FIG. 16 is a block diagram depicting an example of a schematic configuration of a vehicle control system.

FIG. 17 is a diagram of assistance in explaining an example of installation positions of an outside-vehicle information detecting section and an imaging section of the vehicle control system of FIG. 16.

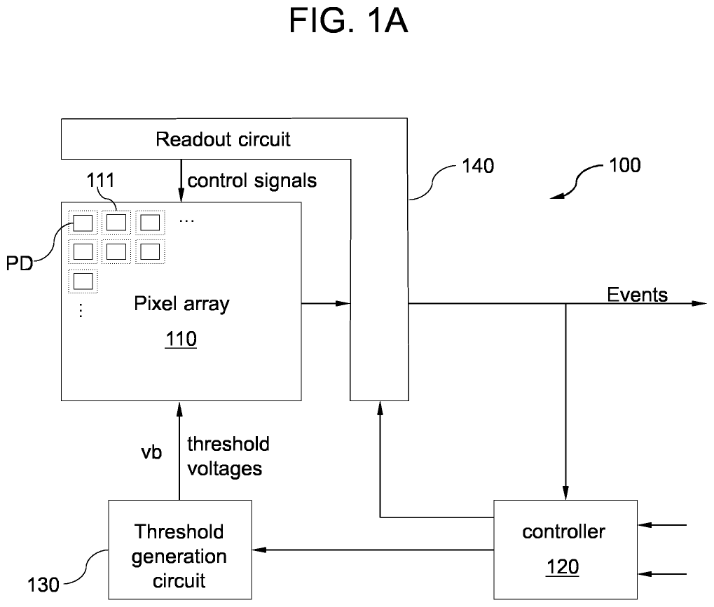

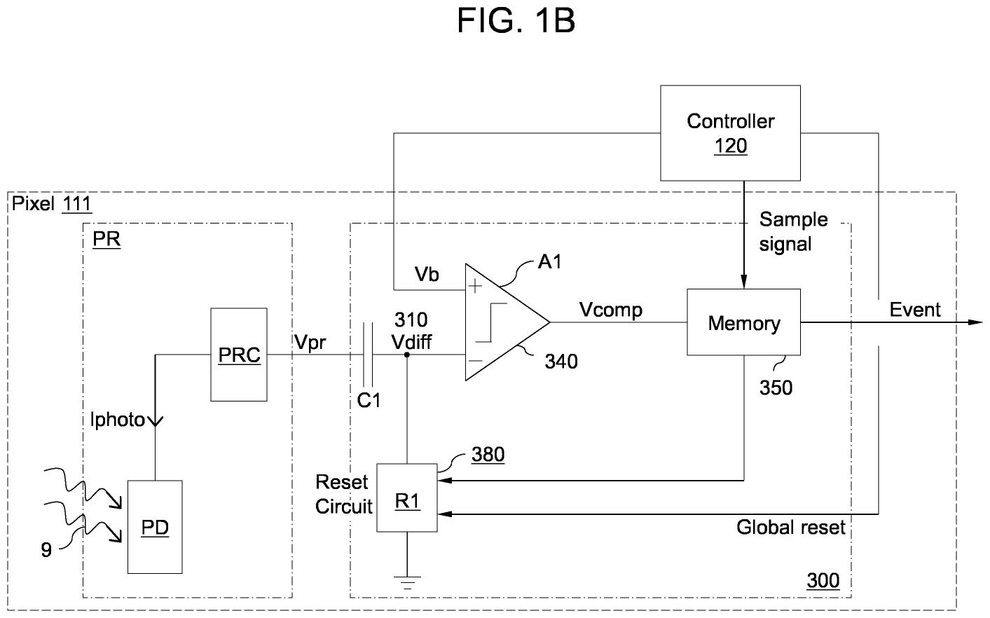

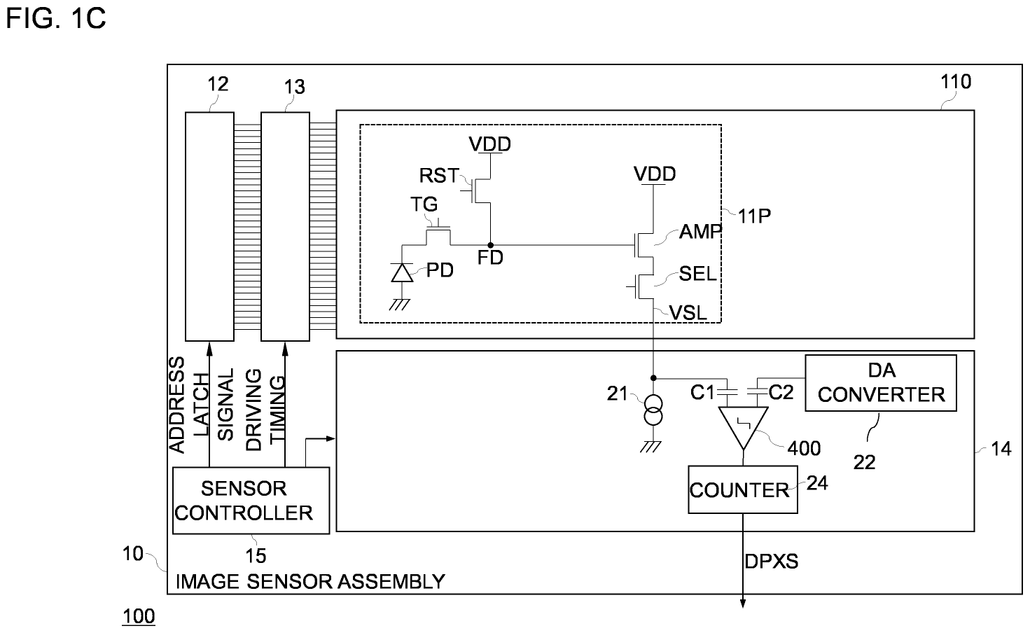

The present disclosure relies on event detection by event visions sensor/dynamic vision sensors. Although these sensors are in principle known to a skilled person a brief overview will be given with respect to FIGS. 1A to 1C.

FIG. 1A is a block diagram of a solid-state imaging device 100 employing event-based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110 may be a two-dimensional array, wherein the photoelectric conversion elements PDs of the pixels 111 may be arranged along straight or meandering rows and along straight or meandering lines.

The illustrations show a two dimensional array of pixels 111, wherein the pixels 111 are arranged along straight rows and along straight columns running orthogonal the rows. Each pixel 111 converts incoming light into an imaging signal representing the incoming light intensity and an event signal indicating a change of the light intensity, e.g. an increase by at least an upper threshold amount (positive polarity) and/or a decrease by at least a lower threshold amount (negative polarity). If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above.

A controller 120 performs a flow control of the processes in the pixel array 110. For example, the controller 120 may control a threshold generation circuit 130 that determines and supplies thresholds to individual pixels 111 in the pixel array 110. A readout circuit 140 provides control signals for addressing individual pixels 111 and outputs information about the position of such pixels 111 that indicate an event. Since the solid-state imaging device 100 employs event-based change detection, the readout circuit 140 may output a variable amount of data per time unit.

FIG. 1B shows exemplarily details of the imaging pixels 111 in FIG. 1A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage which amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node. Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 May be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 1A.

If the state of the stored comparator output signal indicates a change in light intensity AND the global reset signal GlobalReset (controlled by the controller 120) is active, the conditional reset circuit 380 outputs a reset output signal that resets Vdiff to a known level.

The memory element 350 may include information indicating a change of the light intensity detected by the pixel 111 by more than a threshold value.

The solid state imaging device 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events. Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device.

FIG. 1C illustrates a configuration example of the solid-state imaging device 100 including an image sensor assembly 10 that is used for readout of intensity imaging signals in form of an active pixel sensor, APS. Here, FIG. 1C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to a signal processing unit. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14.

Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

An event sensor as described above might be used in the following, when it is referred to event detection. However, any other manner of implementation of event detection might be applicable. In particular, event detection may also be carried out in sensors directed to external influences other than light, like e.g. sound, pressure, temperature or the like. In principle, the below description could be applied to any sensor that provides a binary output in response to the detection of intensities.

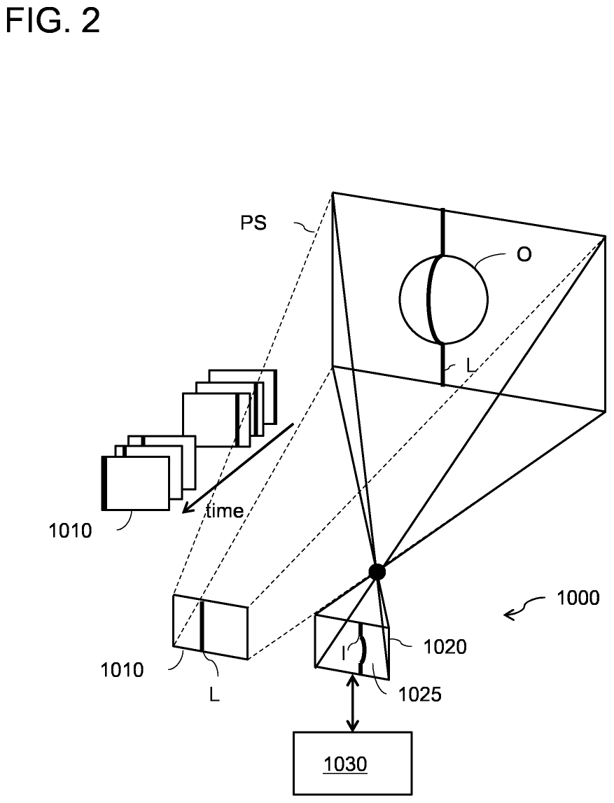

FIG. 2 shows schematically a sensor device 1000 for measuring a depth map of an object O, i.e. a device that allows deduction of distances of surface elements of the object O to the sensor device 1000. The sensor device 1000 may be capable to generate the depth map itself or may only generate data based on which the depth map can be established in further processing steps.

The sensor device 1000 comprises a projector unit 1010 configured to illuminate different locations of the object O during different time periods with an illumination pattern. In particular, the projector unit 1010 is configured to project in a temporally consecutive manner a plurality of different illumination patterns in a projection solid angle PS to the object O, where the projection solid angle PS consists of a predefined number of predetermined solid angles and each illumination pattern is generated by deciding for each of the predetermined solid angles whether or not to illuminate the respective predetermined solid angle by projecting light into it.

In the exemplary illustration of FIG. 2 and the following description illumination patterns consisting of lines L will be used, where the positions of the lines L changes with time such that during different time periods different parts of the object O are illuminated with the lines L. In this case the predetermined solid angles have linear or rectangular cross sections and are parallel to each other in a cross sectional plane. Preferably, the predetermined solid angles are adjacent to each other such that they completely fill the projection solid angle PS. However, the predetermined solid angles may also be separated from each other by a certain distance such that predetermined solid angles are separated by non-illuminated regions.

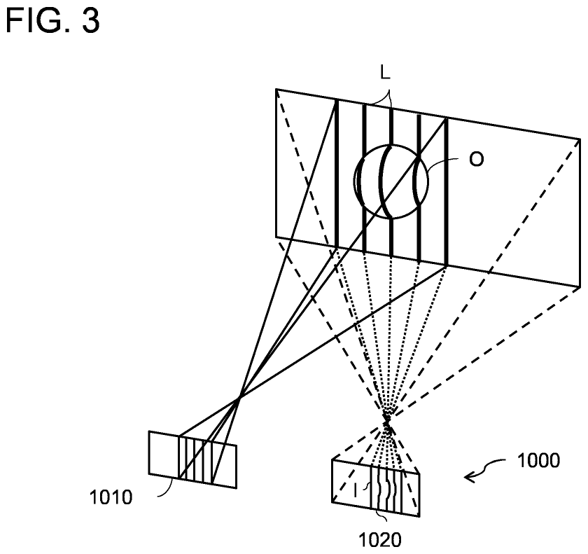

While FIG. 2 shows an example, in which only one line is projected to the object O, also several lines may be projected at the same time, as schematically shown in FIG. 3. Note that the equidistant arrangement of lines in FIG. 3 is only chosen for simplicity. The lines may have arbitrary positions. Also the number of lines, i.e. the number of illuminated predetermined solid angles may change with time.

Although the below description focuses on the line example illustrated in FIGS. 2 and 3, a skilled person readily understands that also other sparse illumination patterns may be used such as checkerboard patterns or even pixel-wise illumination. In all these cases the smallest units that can be illuminated separately form the predetermined solid angles.

The change of the illumination may be effected e.g. by using a fixed light source, the light of which is deflected at different times at different angles. For example, a mirror tilted by a micro-electro-mechanical system (MEMS) might be used to deflect the illumination pattern and/or a refractive grating may be used to produce a plurality of lines. Alternatively, an array of vertical-cavity surface-emitting lasers (VCSELs) or any other laser LEDs might be used that illuminate different parts of the object O at different times. Further, it might also be possible to use shielding optics like slit plates or LCD-panels to produce time varying illumination patterns.

Alternatively, the illumination pattern sent out from the projector unit 1010 may be fixed, while the object O moves across the illumination pattern. In principle, the precise manner of the generation of the illumination pattern and its movement across the objection is arbitrary, as long as different positions of the object O are illuminated during different time periods.

The sensor device 1000 comprises a receiver unit 1020 comprising a plurality of pixels 1025. Due to the surface structure of the object O, the illumination patterns are reflected from the object O in distorted form and forms an image I of the illumination pattern on the receiver unit 1020. The pixels 1025 of the receiver unit 1020 may in principle be capable to generate a full intensity image of the received reflection. More importantly, the receiver unit 1020 is configured to detect on each pixel 1025 intensities of light reflected from the object O while it is illuminated with the illumination pattern, and to generate an event at one of the pixels 1025 if the intensity detected at the pixel 1025 changes by more than a predetermined threshold. Thus, the receiver unit 1020 can act as an event sensor as described above with respect to FIGS. 1A to 1C that can detect changes in the received intensity that exceed a given threshold. Here, positive and negative changes might be detectable, leading to events of so-called positive or negative polarity. Further, the event detection thresholds might be dynamically adaptable and might differ for positive and negative polarities.

The sensor device 1000 further comprises a control unit 1030 that is configured to control the form of the illumination patterns, to receive event data indicating the events generated while the object is illuminated with the illumination patterns, and to generate a depth map of the object based on the received event data. Here, the control unit 1030 is configured to control the form of the illumination patterns such that the temporal sequence of illuminations of each predetermined solid angle allows determining from the event data which of the predetermined solid angles has been mapped to which of the pixels 1025 by reflection of the illumination pattern on the object O.

Here, the control unit 1030 may be any arrangement of circuitry that is capable to carry out the functions described above. For example, the control unit 1030 may be constituted by a processor. The control unit 1030 may be part of the pixel section of the sensor device 1000 and may be placed on the same die(s) as the other components of the sensor device 1000. But the control unit 1030 may also be arranged separately, e.g. on a separate die. The functions of the control unit 1030 may be fully implemented in hardware, in software or may be implemented as a mixture of hardware and software functions.

The sensor device 1000 uses not any arbitrary series of illumination patterns, as e.g. illumination patterns used in standard structured light applications, but illumination patterns that are specifically designed such as to produce event data that allows an accurate mapping of the spatial distribution of events over the pixels 1025 to the illuminated predetermined solid angles that caused these events. In particular, the illumination of the predetermined solid angles is chosen such that adjacent or neighboring predetermined solid angles can be reliably distinguished from each other.

Specific examples how to control the illumination patterns in order to achieve this goal will be discussed in detail below. However, it has to be emphasized that also different control schemes might be used. What is essential is that a specifically selected series of illumination patterns is used that is adapted to allow accurate depth map generation based alone on the detected events. The actually used series of illumination patterns or the rules to obtain them are arbitrary as long as they satisfy the above condition.

Here, the illumination patterns might be determined before operation of the sensor device 1000. For example, one or several allowed series of illumination patterns may be stored in a memory of the sensor device 1000 or the control unit 1030. The control unit 1030 can then choose among these predetermined series of illumination patterns. However, it might also be possible that the control unit 1030 generates illumination patterns during operation of the sensor device 1000, e.g. by an artificial intelligence algorithm that has been trained e.g. by simulating illumination of objects of known shape and the corresponding event detection and providing feedback based on the accuracy of the depth map generated in this manner.

For example, the control unit 1030 may control the form of the illumination patterns such that the determination of which of the predetermined solid angles has been mapped to which of the pixels 1025 is possible by only considering events having a positive polarity, which are events that are generated by an increase of the detected intensity by more than a positive polarity threshold.

By illuminating one of the predetermined solid angles pixels observing this predetermined solid angle will observe an increase in intensity, which will result in a positive polarity event. When the illumination of the predetermined solid angle is turned off again, the intensity will decrease. This will result in a negative polarity event. Thus, in principle the occurrence of illumination on the object due to illuminating the predetermined solid angle should be observable from positive polarity events as well as from negative polarity events. Therefore,

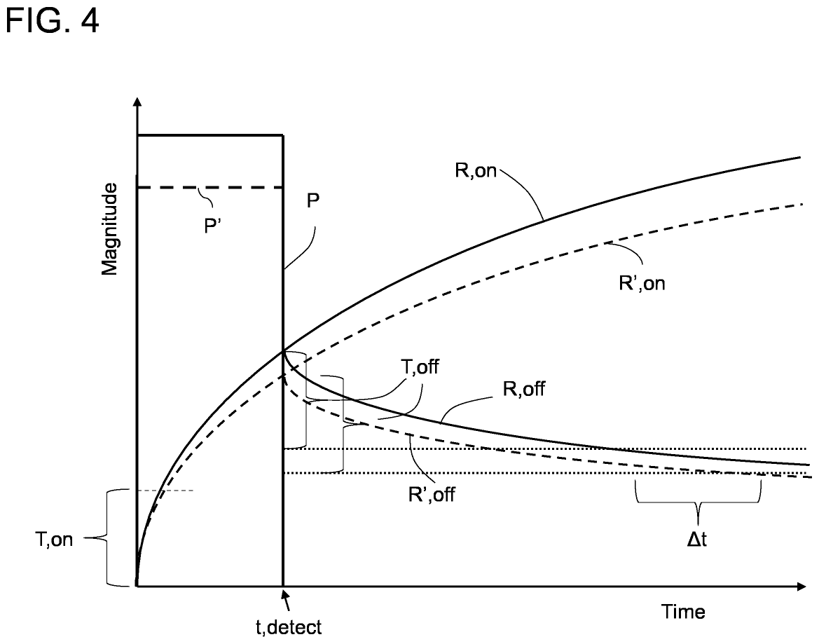

prior art depth map generation in which structured light is detected by events often focus on both, positive and negative polarity events. However, relying on negative polarity events may be a cause of error as will be explained with respect to FIG. 4.

FIG. 4 schematically shows in a time vs, intensity diagram the occurrence of a light pulse P detected by a pixel 1025 due to illumination of one of the predetermined solid angles. The light pulse P has a greater intensity than a positive polarity threshold T,on. Thus, the pulse P will produce a positive polarity event. This positive polarity event will be detected at the time t,detect, i.e. right at the end of the light pulse P. After detection a new reference level will be set and the off event threshold T.off will be measured relative to this new reference level. The magnitude of the reference level is determined by the pixel response characteristic R,on that increases asymptotically to the magnitude of the pixel. Thus, as shown in FIG. 4 a pulse P′ having a smaller magnitude than the pulse P will lead to a different response characteristic R′,on and to a lower reference level.

The time at which the negative polarity event is detected will fluctuate then for two reasons. First, the higher the new reference level is, i.e. the further away from zero the level is, the quicker will the discharge happen. Thus, if the starting point of the discharge is slightly lower (i.e. less far away from the asymptotic value of zero), this will cause a relatively large shift Δt of the detection time of the negative polarity event, as is illustrated in FIG. 4 by the discharge characteristic curves R,off and R′,off. Second, due to the fact that the discharge characteristic R,off is flatter than the charging characteristic R,on, noise will have a stronger influence on the actual timing of the negative polarity event. In fact, a slight additive offset of the reference level will cause a large shift in time.

The point in time at which a negative polarity event is detected has therefore a relatively large temporal fluctuation. This leads to a decreased accuracy, if one tries to generated depth maps based on negative polarity event data, since the temporal uncertainty might lead to a mix-up of temporally consecutive illumination patterns. This is in particular the case, if the temporal resolution of the depth map generation is high, i.e. if the duration of a single illumination pattern is of the same order as the temporal fluctuation of the negative event detection. Accordingly, focusing on positive polarity event detection increases the accuracy of the depth map generation process. Moreover, it has to be noted that the delay for positive polarity event detection is usually smaller than the delay for negative polarity event detection.

In working on positive polarity events the control unit may be configured to form the illumination patterns such that they satisfy the following first criterion: if a time series of N consecutive illumination periods of each predetermined solid angle is considered to form a code word. CW, having a length of N symbols, where each symbol has either a value of 1 for a carried out illumination or a value of 0) for no illumination, then for each code word transitions from 0) to 1 are distributed over the N symbols such that no pair of code words has the same number of transitions at the same symbol positions.

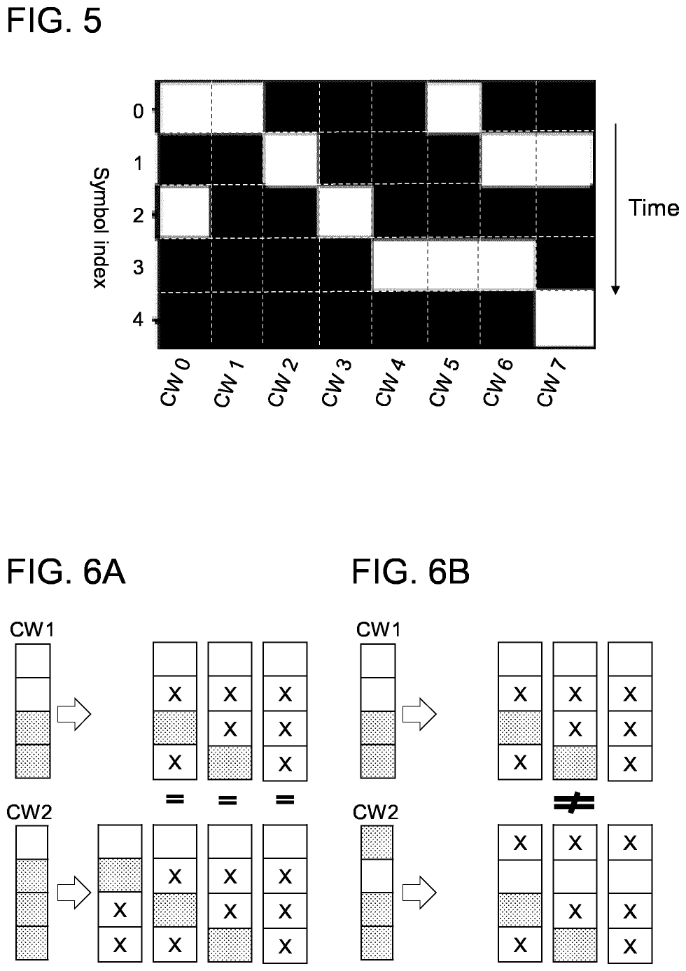

This is illustrated with respect to FIG. 5. FIG. 5 shows a symbolization of the change of illumination patterns over time. Here, the illumination patterns are formed by illuminating 8 different predetermined solid angles, e.g. by projecting lines at 8 different locations onto an object, or by illuminating 8 different (preferably rectangular) areas on the object, which might even have a resolution comparably to those of the pixels 1025 of the reception unit 1020.

Projecting light into one of the 8 predetermined solid angles of FIG. 5 is indicated by a white square, while missing illumination is illustrated by a black square. In a binary representation, illumination/white may be represented by a “1” and missing illumination/black by a “0”. FIG. 5 shows a sequence of 5 consecutive illumination periods. This leads then for each of the 8 predetermined solid angles to a code word. CW, having a length of N=5 symbols.

In order to have illumination patterns that are robust to temporal pixel dynamics transitions from 0 to 1, i.e. from no illumination to illumination should be distributed such over the different code words that all code words differ from each other for at least one transition. This means, no pair of code words has an identical number of transitions that are located at the same symbols.

This requirement is for example satisfied by the illumination patterns symbolized in FIG. 5. Apparently, CW1 to CW4 differ from each other, since transitions from 0 to 1, i.e. from black to white are located at the beginning of symbols 0, 1, 3, and 4, respectively. CW0 and CW5 have transitions at the beginning of symbol 0, just as CW1. But CW0 and CW5 have additional transitions hat the beginning of symbols 2 and 3, respectively. Just the same, although CW6 and CW7 have transitions at the beginning of symbol 1, such as CW2, they have additional transitions at the beginning of symbols 3 and 4, respectively.

The effect of satisfying this first criterion is explained with respect to FIGS. 6A and 6B. FIG. 6A shows two code words. CW1 and CW2 that symbolize two different illumination sequences of one predetermined solid angle.

While according to CW1 the predetermined solid angle is illuminated for the first two consecutive illumination periods, according to CW2 illumination stops after the first illumination period. Thus, one would in principle expect that these two illumination schemes are distinguishable.

However, as illustrated on the right hand side of FIG. 6A, due to the possible temporal fluctuation for the occurrence of the negative polarity events, each of the code words CW1 and CW2 can lead to a series of different event signatures. Here, the right hand side of FIG. 6A shows different time series of pixel responses that can be caused by each of the code words. A white rectangle indicates an ON-event, a shaded rectangle indicates an OFF-event, and an X indicates occurrence of no event.

For CW1 the first pixel response will be an ON-event, due to the illumination during the first illumination period. The temporally consecutive second pixel response will be no event, since illumination continues. Then, illumination is switched off. Due to the temporal fluctuation of the OFF-events, this will either lead directly to an OFF-event (first column) or to an OFF-event that is shifted by one (second column) or several (third column) illumination periods. Thus, for CW1 generation of at least three different event sequences can be expected.

For CW2 the situation is analogous. The illumination during the first illumination period will cause an ON-event. Switch off of the illumination causes an OFF-event that may however by shifted by no, one, two or three or more illumination periods. Thus, for CW2 four different event sequences are possible.

As one can see by comparing the event distributions of the three possible event sequences of CW1 with the last three event sequences possible for CW2, there is an overlap in the sequence pattern. Thus, it is in principle not possible to tell whether a pixel detecting one of these event sequences has seen illumination of the predetermined solid angle symbolized by CW1 or illumination of the predetermined solid angle symbolized by CW2.

Accordingly, it is not possible to provide a map between pixel location and illumination pattern, which is necessary for depth estimation via triangulation. The basic reason for this is that CW1 and CW2 of FIG. 6A both have only one transition from 0 to 1 (i.e. one switch on of illumination) at the same instance of time, i.e. at the same symbol position, which is in the case of FIG. 6A the beginning of the first symbol. Due to the temporal pixel dynamics causing an uncertain time shift of the OFF-events, it is not possible to distinguish the code words by the fact that the switch off of illumination occurs at different times.

This situation has to be contrasted to the situation in FIG. 6B, in which the two code words CW1 and CW2 satisfy the first criterion, i.e. in which the two code words have transitions from 0 to 1 at different symbol positions. Here. CW1 is the same as in the case of FIG. 6A, i.e. switch on of illumination in the first two illumination periods followed by no illumination in the next two illumination periods. However. CW2 represents missing illumination in the first illumination period, illumination in the second illumination period, and no illumination in the last two illumination periods.

This leads to possible event sequences as shown on the right hand side of FIG. 6B. The sequences possible for CW1 are as discussed with respect to FIG. 6A. The event sequences for CW2 of FIG. 6B have no event for the first illumination period, due to the missing illumination. This is followed by an ON-event due to the start of illumination. The end of illumination leads due to the temporal pixel dynamics to an OFF-event either directly after the ON-event or shifted by one or more illumination periods.

It is apparent that the event sequences produced by CW1 and CW2 of FIG. 6B differ from each other due to the different location of the OFF-ON-transition. While for all event sequences possible for CW1 the ON-event is in the first illumination period, it is certainly in the second illumination period for CW2. Thus, the two code words are distinguishable by looking only at the positive polarity events, which represent the transitions from low to high light intensity, i.e. transitions from 0 to 1 in the code words.

Applying the concept discussed with respect to FIGS. 6A and 6B e.g. to the temporal sequence of illumination patterns encoded by the code words shown in FIG. 5, one sees that all these code words can be distinguished with certainty from each other by observing positive polarity events. It is therefore possible to determine from the event sequence detected at one or a plurality of pixels 1025, which predetermined solid angle these pixels 1025 observed. This allows a precise mapping of the reflection of the illumination of a specific predetermined solid angle on the object O to the respective pixel(s) 1025. Based on this mapping a precise triangulation can be performed in the process of depth map generation, which increases the accuracy of the depth map.

A further problem can occur, if the resolution of the pixel array of the receiver unit 1020 does not exactly match the resolution of the reflection of the predetermined solid angles on the object O. In particular, the situation might arise rather often that the illumination of two or more predetermined solid angles hits one pixel 1025, e.g. due to the line profile or the power of the projector unit 1010, the distance or the reflectance of the surface of the object O or the viewing direction of the receiving pixel 1025.

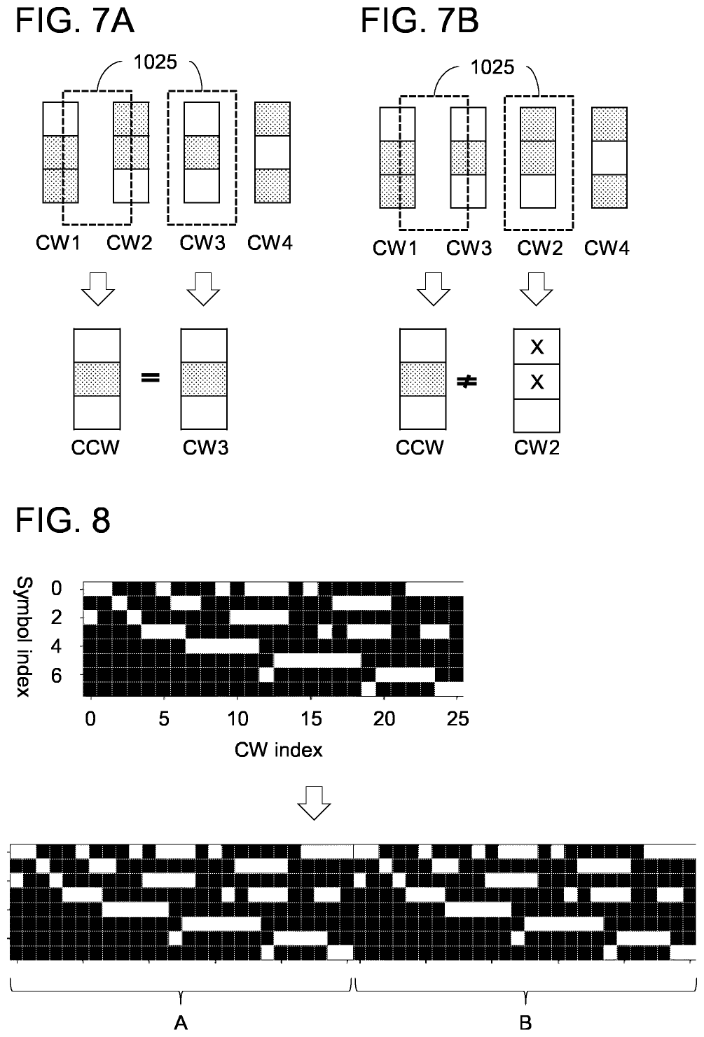

This is schematically shown in the upper part of FIGS. 7A and 7B. Here, the broken lines indicate sensitive areas of pixels 1025. One of the pixels receives light from illuminations represented by two code words, while the other (for example) receives light only from another code word. In this case, the event sequence generated by the pixel 1025 receiving light from two predetermined solid angles will reflect the change of illumination in both predetermined angles. In terms of code words, the respective pixel 1025 sees light symbolized by a combined code word. CCW, that is generated by an OR operation of the two code words that are observable by the pixel 1025. In fact, the OR operation will lead to a 1 in each symbol of the combined code word in which either one of the code words that are combined has a 1 and leave 0 only there, were both code words have zero.

As can be seen from the example of FIGS. 7A and 7B combining CW1 (1,0,0) and CW2 (0,0,1) in this manner leads to the CCW (1,0,1). Combining CW1 and CW3 (1,0,1) leads also to the CCW (1,0,1).

This might lead to a situation where the event sequence generated by this combined code word is equal (within the ambiguities of the point in time of OFF-event detection) to the event sequence generated by another code word. This is the situation in FIG. 7A where the combined code word CCW is equal to CW3. Thus, in this case, a clear discrimination which pixel 1025 observed which predetermined solid angle is not possible. This leads of course to an imprecise mapping and hence to a reduced accuracy and reliability of the depth map generation process.

To mitigate this additional problem the control unit 1030 may be configured to form the illumination patterns such that they satisfy additionally the following second criterion: if a combination of a predetermined number of, preferably two, spatially neighboring code words with an OR operation is called a combined code word, then for each combined code word transitions from 0 to 1 are distributed over the N symbols of the combined code word such that none of the code words spatially neighboring the combined code word have the same number of transitions at the same symbol positions.

Differently stated, the first criterion defined above holds also for combined code words and their neighboring code words. This is illustrated in FIG. 7B, where the spatial arrangement of the illumination patterns symbolized by CW2 and CW3 are exchanged with respect to the situation of FIG. 7A. As stated above, this results in a combination CCW of CW1 and CW3 with symbol sequence (1,0,1). The neighboring code word CW2 has symbol sequence (0,0,1). The resulting event sequences can therefore be clearly distinguished, since the combined code word CCW causes positive polarity events at the first and the third illumination period, while CW2 causes only one positive polarity event at the third illumination period.

Of course, the situation may arise that more than one pixel 1025 (or more than one pixel group) receives light from the illumination of more than one predetermined solid angle. Thus, the above second criterion can be extended such that the first criterion is also satisfied by neighboring combined code words. This provides additional reliability of the mapping of predetermined solid angles to pixels 1025. Further, also more than two code words may be observed by a single pixel 1025. Thus, it might be necessary to extend the above considerations to combined code words obtained by an OR operation of more than two code words.

Finally, there can also be the situation that the spatial order of predetermined solid angles is not maintained in the reflection of the illumination patterns from the object O. For example, if the predetermined solid angles correspond to lines, a spatial order of projectable lines L1, L2, L3, L4, . . . , Ln may be given before reflection on an object, while after reflection a different spatial order is observable, like e.g. L4, L1, L2, L3, L5, . . . , Ln. For this reason, it can be preferable to ensure that illumination patterns are chosen such that a potential mixing of the observable predetermined solid angles does not lead to ambiguities in the mapping between predetermined solid angles and pixels 1025.

To this end, the control unit 1030 may control the illumination patterns additionally such that for each combined code word transitions from 0 to 1 are distributed over the N symbols of the combined code word such that none of the spatially neighboring code words beyond a predetermined solid angle, as well as none of the neighboring combined code words beyond a predetermined solid angle have the same number of transitions at the same symbol position.

Differently stated, not only the next neighboring code words and combined code words have to satisfy the first criterion with respect to a given code word, but also all code words and combined code words that represent predetermined solid angles arranged beyond one particular predetermined solid angle. Here, the actual distance to the given code word can be a parameter that can be tuned by a user of the sensor device 1000 in order to optimize the result. But the distance might also be set automatically, i.e. by an artificial intelligence process.

In practice, it is desirable to reduce the actual number of code words that need to satisfy the above criteria as well as the number of symbols in each of the code words. Otherwise, code word generation might become a too evolved task.

Here, the fact helps that possible ambiguities in the observation of the illuminations of the predetermined solid angles occur locally, i.e. they affect only a given number of M spatially consecutive predetermined solid angles, like e.g. M lines. Thus, once the spatial distance between predetermined solid angles in one spatial direction becomes larger than this number, the illumination pattern may start to repeat itself without the danger to cause ambiguities. Here, the number M may depend on the use of the sensor device 1000, its actual resolution, baseline and expected depth range (i.e. the difference from the closest to the furthest point) of the measured object. For a small, expected depth range the value of M may be equal to about 30, while for a large depth range the value of M may be equal to about 100. For low resolution sensor devices 1000 observing smooth objects. M may be in the range of 10, while for higher resolutions and edgy objects M may be chosen to be 25, 50, or even 100.

Here, it is of course important that the start of the series of M code words and the end of the series of M code words is chosen such that no ambiguities arise due to the repetition of the series. Accordingly, the control unit 1030 may be configured to form the illumination patterns such that they satisfy the following third criterion: if, after a series of M consecutive code words that are arranged in a given spatial direction, the series of M consecutive code words is repeated in said spatial direction, the first criterion and the second criterion are satisfied also in the boundary region of the two series of M consecutive code words. In this manner it is ensured that repeating a given pattern does not lead to ambiguities.

This is illustrated exemplary in FIG. 8. Here, a series of 26 code words with 7 symbols each forms the building block of the overall spatial pattern. This building block satisfies the above defined first and second criteria. Further, as seen in the lower part of FIG. 8, also by concatenating two identical building blocks A and B, there do not arise ambiguities in the boundary region (constituted for example by the last n code words of A and the first n code words of B, with n=1 . . . 5), since the code words located there do also satisfy the first and second criteria with respect to each other. It should be noted here, that it is in particular the generation of the combined code word obtained from the first and the last code word of the series of M code words that is of interest here. If this code word cannot be mistaken for another (combined) code word of the series, the first and second criteria are usually satisfied.

Similar to the situation of spatial repetition, it is desired to repeat the code words also temporally. In particular, if a high temporal resolution is desired, the illumination periods might only have lengths of 0.1 μs to 1 μs. The necessity to observe the object O for times periods recognizable by a human necessitates in turn that several thousand or more changes in illumination are carried out during one observation. Since dealing with code words of according length would be computationally too complex, it is mandatory to use a repetition of code words of much smaller lengths. In fact, since ambiguities in the mapping of predetermined solid angles to pixels 1025 are of spatial nature, the code words might be rather short and have lengths in the range of N=5 . . . 10. The lengths of the code words is here primarily determined by the necessity to have sufficiently long code words to make a distribution of 1s and 0s possible that satisfies the first, second, and/or third criteria.

In addition, to observe moving objects it is necessary to obtain multiple consecutive depth measurements. Hence, the projected pattern may be repeated multiple times. To reach a high framerate it is beneficial to be able to place consecutive patterns back-to-back in order not to require a break between patterns. Here, a single illumination period might be in the order of 10 to 200 microseconds.

However, in order not to endanger the well behaved set up of a code word building block, as the one illustrated in FIG. 8, it is necessary to ensure that by concatenating the building blocks no unwanted deteriorations of the system occur. In particular, it has to be taken into account that if the first and last symbol of a repeated code word is a 1, this means that the illumination of the respective predetermined code word that starts in the illumination period corresponding to the last symbol is continued in the following illumination period due to repetition of the code word. Thus, in the repeated code word the initial symbol will not produce an ON-event in this situation, but no event, since illumination is merely kept at a high level. This will in turn lead to a situation in which code words that satisfied the first to third criteria in the original building block become ambiguous during the repetition, since the effected event sequence changes due to the concatenation of code words.

To mitigate this additional problem, the control unit 1030 may be configured to form the illumination patterns such that they satisfy the following fourth criterion: each code word does not have a value of 1 as both the first symbol and as the N^{th} symbol. In this case the above problem does apparently not occur.

The same is preferably also applied for the combined code words such that the control unit 1030 is also configured to form the illumination patterns such that they satisfy the following fifth criterion: each combined code word does not have a value of 1 as both the first symbol and as the N^{th} symbol.

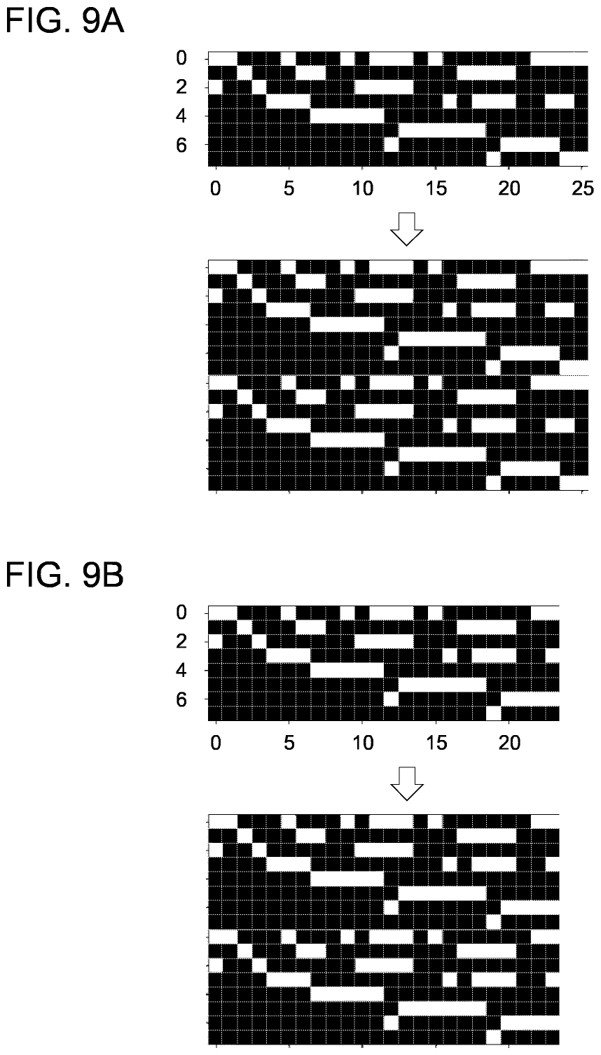

This is schematically illustrated in FIGS. 9A and 9B. FIG. 9A shows the code word building block of FIG. 8 that satisfies the first to third criteria discussed above. However, temporal repetition of this building block shows the above discussed problem for the last two code words. Here, in the transition from the last symbol of the first occurrence of these code words to the first symbol of the second occurrence, no positive polarity event will be generated. Although it is possible to circumvent this problem by selecting all other code words such that they cannot be mixed up with the last code words in which the first symbol is set to 0 instead of 1 (as is the case in FIG. 9A), it is easier to simply avoid code words with first and last symbol being equal to 1. In addition, this produces shorter code words and hence allows higher possible update rates. Thus, an according improved building block is shown in FIG. 9B, in which the last two code words have been deleted.

Here, it should be noted that in general also different building blocks may be concatenated spatially or temporally, if the above third, fourth and/or fifth criteria for the boundary regions are satisfied for each of these building blocks.

By comprising a control unit 1030 that is configured to control generation of illumination patterns such that they satisfy at least the first criterion, the sensor device can reduce possible ambiguities in the task of identifying which of the predetermined solid angles was observed by which of the pixels 1025. This is further improved by implementing also the other criteria discussed above. This give one example of a control unit 1030 that controls illumination pattern such that the mapping of predetermined solid angles to pixels can be obtained by detecting events, in particular positive polarity events. Of course, a skilled person might also conceive different implementations of this general principle.

In the following exemplary fields of use of the sensor device 1000 presented above will be discussed briefly.

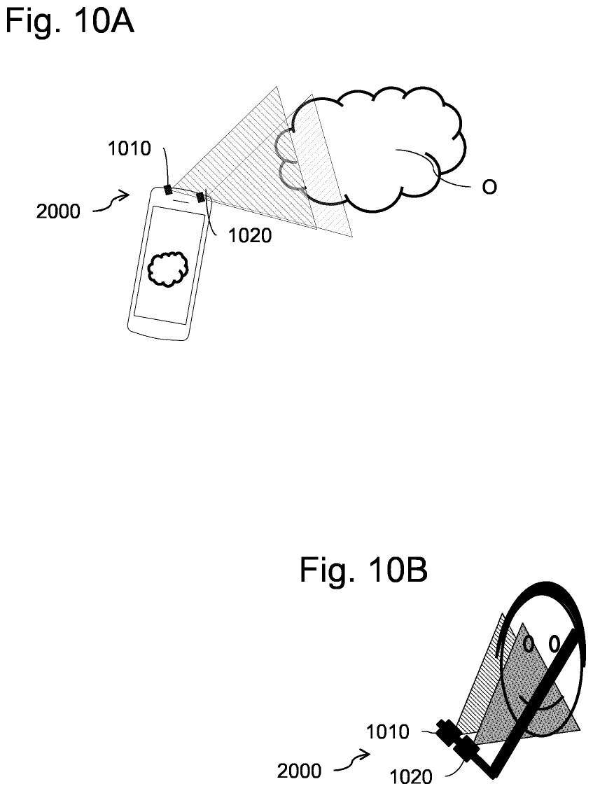

FIGS. 10A and 10B show schematically camera devices 2000 that comprise the sensor device 1000 described above. Here, the camera device 2000 is configured to generate a depth map of a captured scene based on the positions of the images of the illumination patterns obtained for each illumination period.

FIG. 10A shows a smart phone that is used to obtain a depth map of an object O. This might be used to improve augmented reality functions of the smart phone or to enhance game experiences available on the smart phone. FIG. 10B shows a face capture sensor that might be used e.g. for face recognition at airports or boarder control, for viewpoint correction or artificial makeup in web meetings, or to animate chat avatars for web meeting or gaming. Further, movie/animation creators might use such an EVS-enhanced face capture sensor to adapt animated figures to real live persons.

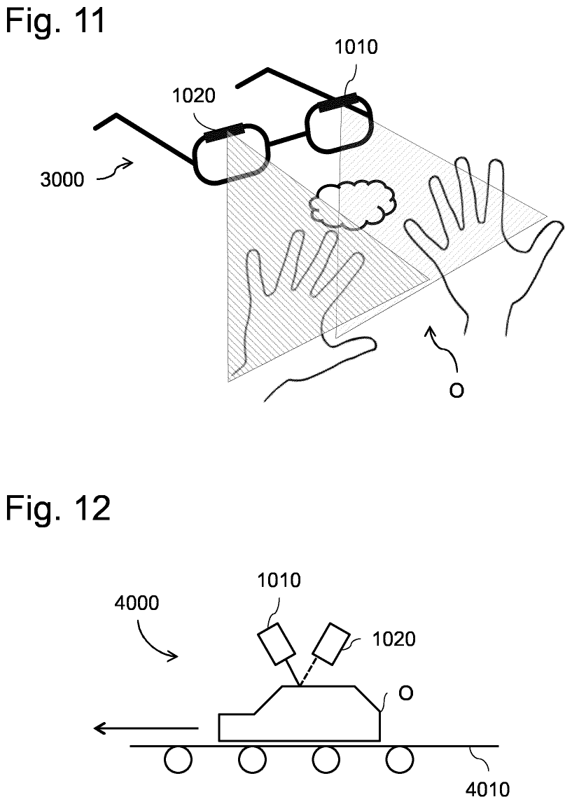

FIG. 11 shows as further example a head mounted display 3000 that comprises a sensor device 1000 as described above, wherein the head mounted display 3000 is configured to generate a depth map of an object O viewed through the head mounted display 3000 based on the position of the images of the illumination patterns. This example might be used for accurate hand tracking in augmented reality or virtual reality applications, e.g. in aiding complicated medical tasks.

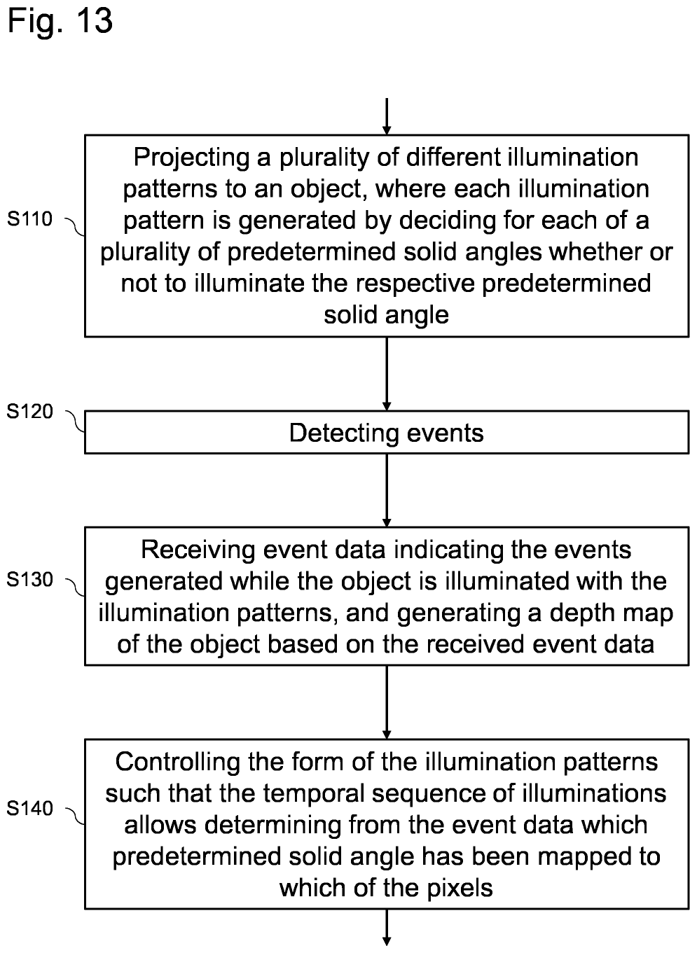

FIG. 12 shows schematically an industrial production device 4000 that comprises a sensor device 1000 as described above, wherein the industrial production device 4000 comprises means 4010 to move objects O in front of the projector unit 1010 in order to (partly) achieve the projection of the illumination pattern onto different locations of the objects O, and the industrial production device 4000 is configured to generate depth maps of the objects O based on the positions of the images of the illumination patterns. This application is particularly adapted to EVS-enhanced depth sensors, since conveyor belts constituting e.g. the means 4010 to move objects O have a high movement speed that allows depth map generation only if the receiver unit 1020 has a sufficiently high time resolution. Since this is the case for the EVS-enhanced sensor devices 1000 described above accurate and high speed depth maps of industrially produced objects O can be obtained that allows fully automated, accurate, and fast quality control of the produced objects O.

FIG. 13 summarizes the steps of the method for measuring a depth map of an object O with a sensor device 1000 described above. The method for operating a sensor device 1000 for generating a depth map of the object O comprises:

At S110 projecting in a temporally consecutive manner a plurality of different illumination patterns in a projection solid angle PS to the object O, where the projection solid angle PS consists of a predefined number of predetermined solid angles and each illumination pattern is generated by deciding for each of the predetermined solid angles whether or not to illuminate the respective predetermined solid angle by projecting light into it.

At S120 detecting, on each of a plurality of pixels 1025, intensities of light reflected from the object O while it is illuminated with the illumination patterns, and generating an event at one of the pixels 1025 if the intensity detected at the pixel 1025 changes by more than a predetermined threshold.

At S130 receiving event data indicating the events generated while the object O is illuminated with the illumination patterns, and generating a depth map of the object O based on the received event data.

At S140 controlling the form of the illumination patterns such that the temporal sequence of illuminations of each predetermined solid angle allows determining from the event data which of the predetermined solid angles has been mapped to which of the pixels 1025 by reflection of the illumination pattern on the object O.

In this manner the above-described enhancement in accuracy and reliability of event based depth map generation can be obtained. Here, it should be noted that the order of steps shown in FIG. 13 is arbitrary and that steps S110 to S140 might also be arranged differently. In particular. S140 may be performed first.

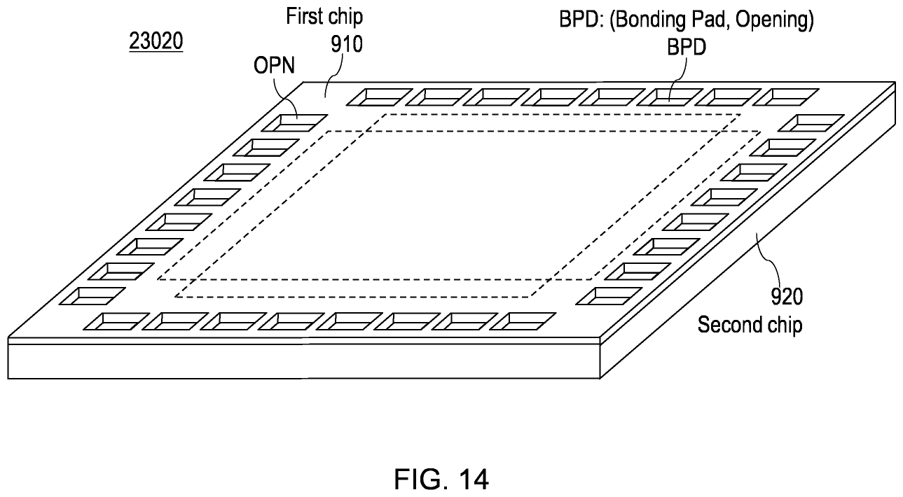

FIG. 14 is a perspective view showing an example of a laminated structure of a solid-state imaging device 23020 with a plurality of pixels arranged matrix-like in array form in which the functions described above may be implemented. Each pixel includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S) Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel, e.g., the photoelectric conversion elements arranged in array form. For example, the first chip 910 may include only the photoelectric conversion elements.

Alternatively, the first chip 910 may include further elements of each photoreceptor module. For example, the first chip 910 may include, in addition to the photoelectric conversion elements, at least some or all of the n-channel MOSFETs of the photoreceptor modules. Alternatively, the first chip 910 may include each element of the photoreceptor modules.

The first chip 910 may also include parts of the pixel back-ends 300. For example, the first chip 910 may include the memory capacitors, or, in addition to the memory capacitors sample/hold circuits and/or buffer circuits electrically connected between the memory capacitors and the event-detecting comparator circuits. Alternatively, the first chip 910 may include the complete pixel back-ends. With reference to FIG. 13A, the first chip 910 may also include at least portions of the readout circuit 140, the threshold generation circuit 130 and/or the controller 120 or the entire control unit.

The second chip 920 may be mainly a logic chip (digital chip) that includes the elements complementing the circuits on the first chip 910 to the solid-state imaging device 23020. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration;

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

Typically, the first chip 910 includes a p-type substrate and formation of p-channel MOSFETs typically implies the formation of n-doped wells separating the p-type source and drain regions of the p-channel MOSFETs from each other and from further p-type regions. Avoiding the formation of p-channel MOSFETs may therefore simplify the manufacturing process of the first chip 910.

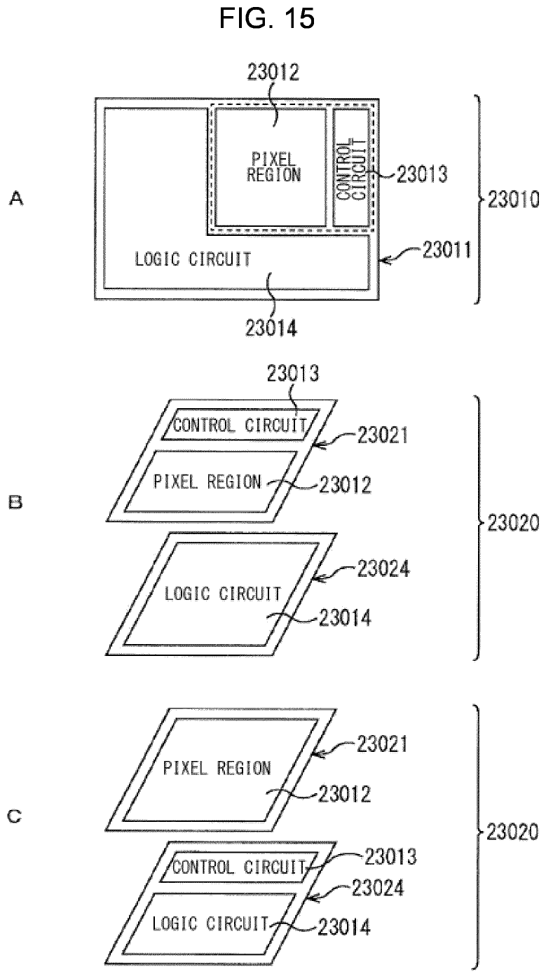

FIG. 15 illustrates schematic configuration examples of solid-state imaging devices 23010, 23020.

The single-layer solid-state imaging device 23010 illustrated in part A of FIG. 15 includes a single die (semiconductor substrate) 23011. Mounted and/or formed on the single die 23011 are a pixel region 23012 (photoelectric conversion elements), a control circuit 23013 (readout circuit, threshold generation circuit. controller, control unit), and a logic circuit 23014 (pixel back-end). In the pixel region 23012, pixels are disposed in an array form. The control circuit 23013 performs various kinds of control including control of driving the pixels. The logic circuit 23014 performs signal processing.

Parts B and C of FIG. 15 illustrate schematic configuration examples of multi-layer solid-state imaging devices 23020 with laminated structure. As illustrated in parts B and C of FIG. 15, two dies (chips), namely a sensor die 23021 (first chip) and a logic die 23024 (second chip), are stacked in a solid-state imaging device 23020. These dies are electrically connected to form a single semiconductor chip.

With reference to part B of FIG. 15, the pixel region 23012 and the control circuit 23013 are formed or mounted on the sensor die 23021, and the logic circuit 23014 is formed or mounted on the logic die 23024. The logic circuit 23014 may include at least parts of the pixel back-ends. The pixel region 23012 includes at least the photoelectric conversion elements.

With reference to part C of FIG. 15, the pixel region 23012 is formed or mounted on the sensor die 23021, whereas the control circuit 23013 and the logic circuit 23014 are formed or mounted on the logic die 23024.

According to another example (not illustrated), the pixel region 23012 and the logic circuit 23014, or the pixel region 23012 and parts of the logic circuit 23014 may be formed or mounted on the sensor die 23021, and the control circuit 23013 is formed or mounted on the logic die 23024.

Within a solid-state imaging device with a plurality of photoreceptor modules PR, all photoreceptor modules PR may operate in the same mode. Alternatively, a first subset of the photoreceptor modules PR may operate in a mode with low SNR and high temporal resolution and a second, complementary subset of the photoreceptor module may operate in a mode with high SNR and low temporal resolution. The control signal may also not be a function of illumination conditions but, e.g., of user settings.

### Application Example to Mobile Body

The technology according to the present disclosure may be realized, e.g., as a device mounted in a mobile body of any type such as automobile, electric vehicle, hybrid electric vehicle, motorcycle, bicycle, personal mobility, airplane, drone, ship, or robot.

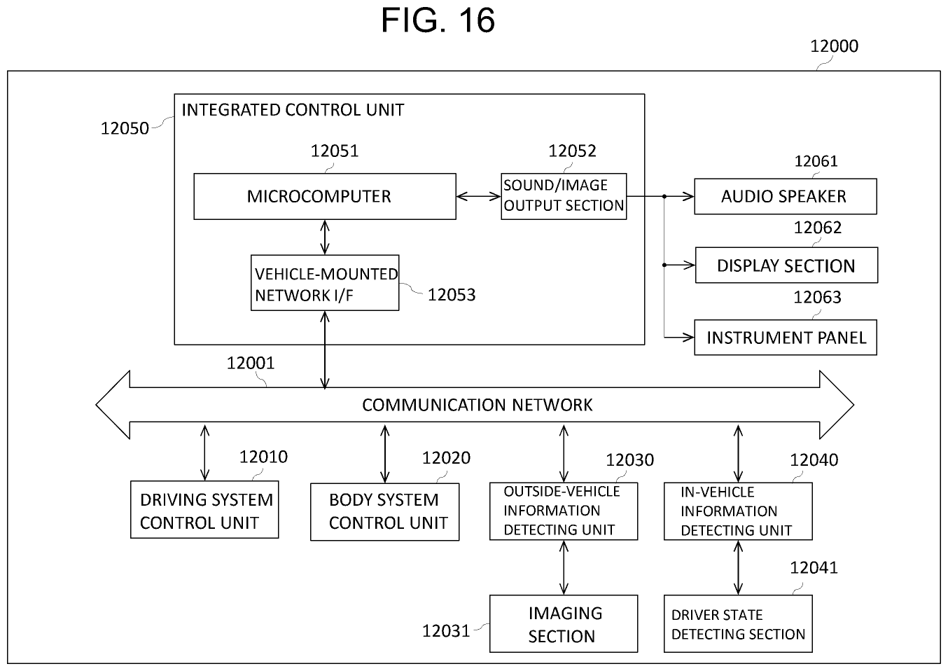

FIG. 16 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging sensor with event detection and photoreceptor modules according to the present disclosure. The imaging section 12031 may output the electric signal as position information identifying pixels having detected an event. The light received by the imaging section 12031 may be visible light, or may be invisible light such as infrared rays or the like.

The in-vehicle information detecting unit 12040 detects information about the inside of the vehicle and may be or may include a solid-state imaging sensor with event detection and photoreceptor modules according to the present disclosure. The in-vehicle information detecting unit 12040 is, for example, connected with a driver state detecting section 12041 that detects the state of a driver. The driver state detecting section 12041, for example, includes a camera focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display or a head-up display.

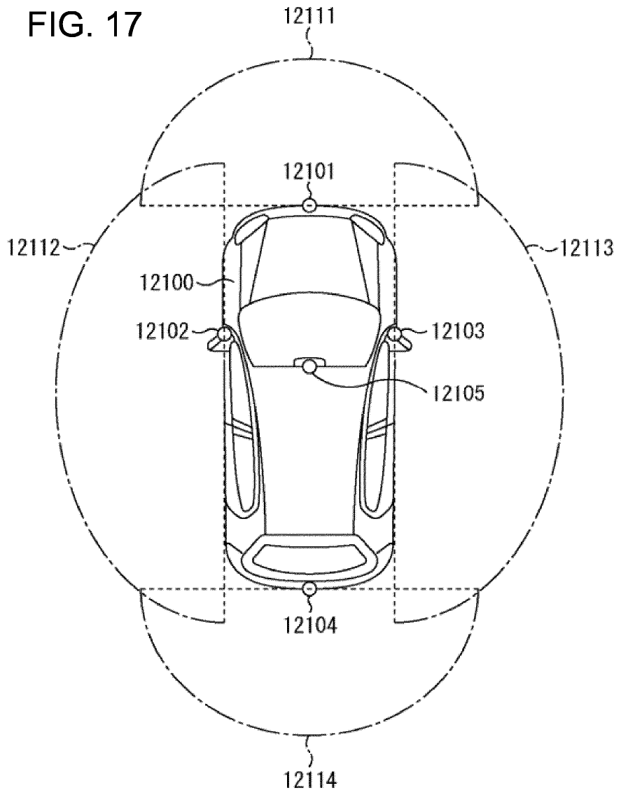

FIG. 17 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally. FIG. 17 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure is applicable has been described above. By applying the photoreceptor modules for obtaining event-triggered image information, the image data transmitted through the communication network may be reduced and it may be possible to reduce power consumption without adversely affecting driving support.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:
(1) A sensor device for generating a depth map of an object comprising:
   a projector unit that is configured to project in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it;
   a receiver unit that comprises a plurality of pixels, the receiver unit being configured to detect on each pixel intensities of light reflected from the object while it is illuminated with the illumination patterns, and to generate an event at one of the pixels if the intensity detected at the pixel changes by more than a predetermined threshold;
   a control unit that is configured to control the form of the illumination patterns, to receive event data indicating the events generated while the object is illuminated with the illumination patterns, and to generate a depth map of the object based on the received event data; wherein
   the control unit is configured to control the form of the illumination patterns such that the temporal sequence of illuminations of each predetermined solid angle allows determining from the event data which of the predetermined solid angles has been mapped to which of the pixels by reflection of the illumination pattern on the object.
(2) The sensor device according to (1), wherein
   the control unit is configured to control the form of the illumination patterns such that the determination of which of the predetermined solid angles has been mapped to which of the pixels is possible by only considering events having a positive polarity, which are events that are generated by an increase of the detected intensity by more than a positive polarity threshold.
(3) The sensor device according to any one of (1) to (2), wherein
   the control unit is configured to form the illumination patterns such that they satisfy the following first criterion: if a time series of N consecutive illumination periods of each predetermined solid angle is considered to form a code word having a length of N symbols, where each symbol has either a value of 1 for a carried out illumination or a value of 0 for no illumination, then for each code word transitions from 0 to 1 are distributed over the N symbols such that no pair of code words has the same number of transitions at the same symbol positions.
(4) The sensor device according to (3), wherein
   the control unit is configured to form the illumination patterns such that they satisfy additionally the following second criterion: if a combination of a predetermined number of, preferably two, spatially neighboring code words with an OR operation is called a combined code word, then for each combined code word transitions from 0 to 1 are distributed over the N symbols of the combined code word such that none of the code words spatially neighboring the combined code word have the same number of transitions at the same symbol positions.
(5) The sensor device according to (4), wherein
   for each combined code word transitions from 0 to 1 are distributed over the N symbols of the combined code word such that none of the spatially neighboring code words beyond a predetermined solid angle, as well as none of the neighboring combined code words beyond a predetermined solid angle have the same number of transitions at the same symbol position.
(6) The sensor device according to any one of (4) to (5), wherein
   the control unit is configured to form the illumination patterns such that they satisfy the following third criterion: if, after a series of M consecutive code words that are arranged in a given spatial direction, the series of M consecutive code words is repeated in said spatial direction, the first criterion and the second criterion are satisfied also in the boundary region of the two series of M consecutive code words.
(7) The sensor device according to (3) to (6), wherein
   the control unit is configured to form the illumination patterns such that they satisfy the following fourth criterion: each code word does not have a value of 1 as both the first symbol and as the N^{th} symbol.
(8) The sensor device according to (4) to (7), wherein
   the control unit is configured to form the illumination patterns such that they satisfy the following fifth criterion: each combined code word does not have a value of 1 as both the first symbol and as the N^{th} symbol.
(9) The sensor device according to any one of (1) to (8), wherein
   the predetermined solid angles are formed such that illumination of the predetermined solid angle leads to projection of parallel lines onto the object.
(10) A method for operating a sensor device for generating a depth map of an object, the method comprising:
   projecting in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it;
   detecting, on each of a plurality of pixels, intensities of light reflected from the object while it is illuminated with the illumination patterns, and generating an event at one of the pixels if the intensity detected at the pixel changes by more than a predetermined threshold;
   receiving event data indicating the events generated while the object is illuminated with the illumination patterns, and generating a depth map of the object based on the received event data; and
   controlling the form of the illumination patterns such that the temporal sequence of illuminations of each predetermined solid angle allows determining from the event data which of the predetermined solid angles has been mapped to which of the pixels by reflection of the illumination pattern on the object.

1. A sensor device for generating a depth map of an object comprising:
a projector unit that is configured to project in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it;
a receiver unit that comprises a plurality of pixels, the receiver unit being configured to detect on each pixel intensities of light reflected from the object while it is illuminated with the illumination patterns, and to generate an event at one of the pixels if the intensity detected at the pixel changes by more than a predetermined threshold; and
a control unit that is configured to control the form of the illumination patterns, to receive event data indicating the events generated while the object is illuminated with the illumination patterns, and to generate a depth map of the object based on the received event data; wherein
the control unit is configured to control the form of the illumination patterns such that the temporal sequence of illuminations of each predetermined solid angle allows determining from the event data which of the predetermined solid angles has been mapped to which of the pixels by reflection of the illumination pattern on the object.

2. The sensor device according to claim 1, wherein
the control unit is configured to control the form of the illumination patterns such that the determination of which of the predetermined solid angles has been mapped to which of the pixels is possible by only considering events having a positive polarity, which are events that are generated by an increase of the detected intensity by more than a positive polarity threshold.

3. The sensor device according to claim 2, wherein
the control unit is configured to form the illumination patterns such that they satisfy the following first criterion: if a time series of N consecutive illumination periods of each predetermined solid angle is considered to form a code word having a length of N symbols, where each symbol has either a value of 1 for a carried out illumination or a value of 0 for no illumination, then for each code word transitions from 0 to 1 are distributed over the N symbols such that no pair of code words has the same number of transitions at the same symbol positions.

4. The sensor device according to claim 3, wherein
the control unit is configured to form the illumination patterns such that they satisfy additionally the following second criterion: if a combination of a predetermined number of, preferably two, spatially neighboring code words with an OR operation is called a combined code word, then for each combined code word transitions from 0 to 1 are distributed over the N symbols of the combined code word such that none of the code words spatially neighboring the combined code word have the same number of transitions at the same symbol positions.

5. The sensor device according to claim 4, wherein
for each combined code word transitions from 0 to 1 are distributed over the N symbols of the combined code word such that none of the spatially neighboring code words beyond a predetermined solid angle, as well as none of the neighboring combined code words beyond a predetermined solid angle have the same number of transitions at the same symbol position.

6. The sensor device according to claim 4, wherein
the control unit is configured to form the illumination patterns such that they satisfy the following third criterion: if, after a series of M consecutive code words that are arranged in a given spatial direction, the series of M consecutive code words is repeated in said spatial direction, the first criterion and the second criterion are satisfied also in the boundary region of the two series of M consecutive code words.

7. The sensor device according to claim 4, wherein
the control unit is configured to form the illumination patterns such that they satisfy the following fourth criterion: each code word does not have a value of 1 as both the first symbol and as the N^{th} symbol.

8. The sensor device according to claim 4, wherein
the control unit is configured to form the illumination patterns such that they satisfy the following fifth criterion: each combined code word does not have a value of 1 as both the first symbol and as the N^{th} symbol.

9. The sensor device according to claim 1, wherein
the predetermined solid angles are formed such that illumination of the predetermined solid angle leads to projection of parallel lines onto the object.

10. A method for operating a sensor device for generating a depth map of an object, the method comprising:
projecting in a temporally consecutive manner a plurality of different illumination patterns in a projection solid angle to the object, where the projection solid angle consists of a predefined number of predetermined solid angles and each illumination pattern is generated by deciding for each of the predetermined solid angles whether or not to illuminate the respective predetermined solid angle by projecting light into it;
detecting, on each of a plurality of pixels, intensities of light reflected from the object while it is illuminated with the illumination patterns, and generating an event at one of the pixels if the intensity detected at the pixel changes by more than a predetermined threshold;
receiving event data indicating the events generated while the object is illuminated with the illumination patterns, and generating a depth map of the object based on the received event data; and
controlling the form of the illumination patterns such that the temporal sequence of illuminations of each predetermined solid angle allows determining from the event data which of the predetermined solid angles has been mapped to which of the pixels by reflection of the illumination pattern on the object.
